(19) United States
(12) Patent Application Publication
(10) Pub. No.: US 2010/0092724 A1
(43) Pub. Date: Apr. 15, 2010

(54) PROCESS FOR PRODUCING CARBON STRUCTURAL BODY, CARBON STRUCTURAL BODY, AND AGGREGATE AND DISPERSION OF CARBON STRUCTURAL BODIES

(75) Inventors: Toshifumi Shiroya, Yokohama-shi (JP); Hiroyuki Aikyou, Yokohama-shi (JP); Masaki Yamamoto, Yokohama-shi (JP); Jun Enda, Yokohama-shi (JP); Masatsugu Shimomura, Yokohama-shi (JP); Sadaaki Yamamoto, Sapporo-shi (JP); Kuniharu Ijiro, Sapporo-shi (JP); Kenji Hijikata, Sapporo-shi (JP); Hiroshi Yabu, Sendai-shi (JP); Yasutaka Matsuo, Sapporo-shi (JP); Masaru Tanaka, Yonezawa-shi (JP)

Correspondence Address: NIXON & VANDERHYE, PC, 901 NORTH GLEBE ROAD, 11TH FLOOR, ARLINGTON, VA, 22203, US

(73) Assignees: MITSUBISHI CHEMICAL CORPORATION, Tokyo (JP); NATIONAL UNIVERSITY CORPORATION HOKKAIDO UNIVERSITY, Sapporo-shi (JP)

(21) Appl. No.: 12/094,474

(22) PCT Filed: Nov. 21, 2006
(86) PCT No.: PCT/JP2006/323225

§ 371 Date: Dec. 22, 2009

(30) Foreign Application Priority Data
Nov. 25, 2005 (JP) 2005-340808

(51) Int. Cl. B32B 3/10; C01B 31/02; B32B 3/26; B32B 3/00

(52) U.S. Cl. 428/131; 264/29.1; 428/221; 428/141; 428/172

(57) ABSTRACT

A process for producing a carbon structural body is provided, with which a carbon structural body having any of various nanostructures can be produced inexpensively and efficiently. The method includes forming a carbon-containing material into a pattern, coating the obtained pattern with a proto-shaped mold, and calcining and carbonizing the coated pattern.

### BACKGROUND OF THE INVENTION

The present invention relates to a process for producing a carbon structural body, to a carbon structural body, and to an aggregate and a dispersion of carbon structural bodies.

Various nanometer-sized carbon materials, such as carbon nanoparticles and carbon nanotubes, have been developed. To apply these materials to a wide variety of applications using their excellent properties, it is necessary to organize the particles or tubes, in other words, to arrange the particles or tubes into regular arrays. It is, however, difficult to arrange nanosized materials into arrays with high practical efficiency.

As high-performance carbon materials having a regular nano-level structure other than carbon nanotubes, carbon materials using a silica mesoporous material or carbon materials having a honeycomb structure have been developed.

As one specific example of the technique for the production of a carbon structural body having a nanostructure using a template, Patent Document 1 discloses a process for producing a nanoporous carbon structural body having mesopores with a size of 2 to 50 nm. The method includes the steps of synthesizing a mesoporous silica mold, polymerizing a polymer in the mold to form a polymer-silica composite, and calcining the polymer-silica composite. In this method, however, it is necessary to synthesize a mold of a mesoporous silica material such as MCM-48 or SBA-15 first. Since this process uses self-assembly of a surfactant, the type of the structure that can be produced is limited. Therefore, the desired structural body is not necessarily produced. In addition, synthesis of a mesoporous silica mold is expensive and is not suitable for industrial utilization.

As an example of a process for producing a carbon structural body having a nanostructure without using a template, Patent Document 2 discloses a process for producing a carbon structural body having fine through-holes. The method includes the steps of forming through-holes through a polyimide film with an excimer laser, and carbonizing the polyimide film. However, the polymers usable in this method are limited to those which are carbonized through a solid-phase carbonization reaction such as polyimide. In addition, since the through-holes are formed with an excimer laser, the production efficiency is low.

There is also a description in Patent Document 2 about a method in which a liquid organic polymer is poured into a mold made of a metal material which evaporates at 2000 K and having a repeating columnar pattern. A high temperature treatment is then carried out to evaporate the mold and to carbonize and graphitize the polymer. However, this method is not practical since the production of the mold takes a great deal of time and cost.

Non-Patent Document 1 discloses a process for producing a honeycomb carbon structural body including forming a honeycomb structure by a self-assembly process using nitrocellulose, and carbonizing the nitrocellulose. However, the polymers usable in this method are also limited to those which are carbonized through a solid-phase carbonization reaction such as nitrocellulose. In addition, since this method uses self-assembly of nitrocellulose, the type of the structure that can be produced is limited.

Patent Document 1: Japanese Patent Application Laid-Open (KOKAI) No. 2004-161590

Patent Document 2: Japanese Patent Application Laid-Open (KOKAI) No. 10-312778

Non-Patent Document 1: Macromolecular Chemistry and Physics, 2000, pp. 2721-2728

### DISCLOSURE OF THE INVENTION

### Problems to be Solved by the Invention

The present invention has been made in view of the above problems. Thus, an object of the present invention is to provide a process for producing a carbon structural body with which a carbon structural body having any of various nanostructures can be produced inexpensively and efficiently, and to provide a novel carbon structural body which can be produced by the above method, and an aggregate and a dispersion of such carbon structural bodies.

### Means for Solving the Problems

As a result of the present inventors' earnest study to solve the above problems, it has been found that a carbon structural body with a desired shape can be produced from various types of polymers efficiently by forming a carbon-containing material into a pattern, coating the obtained pattern with a proto-shaped mold, and calcining and carbonizing the coated pattern. The present inventors have succeeded to produce a novel carbon structural body having a regularly arranged structure by this method and have accomplished the present invention.

Thus, in an aspect of the present invention, there is provided a process for producing a carbon structural body comprising forming a carbon-containing material into a pattern, then coating the pattern with a proto-shaped mold, and calcining and carbonizing the coated pattern (claim 1).

Preferably, a method for the said forming of the carbon-containing material into a pattern is at least one method selected from the group consisting of a nanoimprint method, a soft lithography method and a self-assembly method (claim 2).

In another aspect of the present invention, there is provided a carbon structural body produced by a process for producing a carbon structural body as described above (claim 3).

Preferably the carbon structural body has voids (claim 4).

Preferably the carbon structural body has a surface having regularly arranged fine pores (claim 5).

Preferably the carbon structural body has a surface having regularly arranged fine projections (claim 6).

In a further aspect of the present invention, there is provided a carbon structural body comprising voids defined by carbon walls, and a surface having regularly arranged fine pores (claim 7).

Preferably the fine pores are through-holes (claim 8).

In a still further aspect of the present invention, there is provided a carbon structural body comprising voids defined by carbon walls, and a surface having regularly arranged fine projections (claim 9).

In a still further aspect of the present invention, there is provided a carbon structural body comprising a plurality of particles having voids defined by carbon walls and bonded to each other (claim 10).

In a still further aspect of the present invention, there is provided an aggregate of carbon structural bodies comprising aggregated carbon structural bodies as described above (claim 11).

In a still further aspect of the present invention, there is provided a dispersion of carbon structural bodies comprising aggregates of carbon structural bodies dispersed in a dispersion medium (claim 12).

According to the process for producing a carbon structural body of the present invention, since a carbon-containing material formed into a pattern is coated with a proto-shaped mold and then carbonized by calcination, a carbon structural body with a desired shape can be efficiently produced from various types of polymers. In addition, the method enables a novel carbon structural body having a regularly arranged structure to be produced.

### BRIEF DESCRIPTION OF THE DRAWINGS

FIG. 1 is a TEM photograph (drawing substitute photograph) of a carbon structural body (honeycomb type carbon structural body) obtained in Example 1.

FIG. 2 is a TEM photograph (drawing substitute photograph) of a carbon structural body (fine projection type carbon structural body) obtained in Example 2.

FIG. 3 is a SEM photograph (drawing substitute photograph) of a carbon structural body (dimple type carbon structural bodies) obtained in Example 3.

FIG. 4(a) to FIG. 4(c) are each a SEM photograph (drawing substitute photograph) of a carbon structural body (projection/recess type carbon structural body) obtained in Example 4.

FIG. 5 is a SEM photograph (drawing substitute photograph) of a carbon structural body (colloid crystal type carbon structural body) obtained in Example 5.

FIG. 6 is a view illustrating an example of an outer periphery of a carbon structural body of the present invention having a structure in which the ends of carbon crystals are exposed and a structure in which carbon net planes are in the form of loops.

### BEST MODE FOR CARRYING OUT THE INVENTION

The present invention will be described hereinafter in detail. It should be noted that the present invention is not limited to the following description and various modifications can be made and practiced within the scope of the present invention.

### I. Process for Producing Carbon Structural Body:

For the sake of convenience of description, the process for producing a carbon structural body of the present invention (which will be hereinafter referred to simply as “the production method of the present invention” as needed) is first described.

In the production method of the present invention, a carbon-containing material is formed into a desired pattern (the shaped carbon-containing material body having a pattern may be hereinafter occasionally referred to as “precursor body”). Then, the precursor body is coated with a proto-shaped mold. The precursor body coated with a proto-shaped mold is carbonized by calcination, thereby obtaining a carbon structural body having a desired nanostructure or regularly arranged structure. In this case, it is preferred that the obtained carbon structural body maintains the pattern of the precursor body. The term “maintain” used herein is not limited to preserving exactly the same pattern and may include substantially preserving the pattern.

### I-1. Carbon-Containing Material:

The type of the carbon-containing material is not particularly limited as long as it can be carbonized. Suitable examples of the carbon-containing material include high molecular weight compounds and pitch. Among them, high molecular weight compounds are preferred. More specifically, materials which undergo liquid-phase carbonization and materials containing a readily decomposable polymer are preferred.

The term “liquid-phase carbonization” as used herein is intended to refer to a carbonization process in which a solid reaches a more highly fluidized state than that at its glass transition point (Tg) so that a thermochemical reaction proceeds in a liquid phase to permit migration and orientation of molecules to occur relatively easily during the process. Thus, the term “materials which undergo liquid-phase carbonization” as used herein refers to materials which undergo plastic deformation when heated under the carbonization conditions of the present invention, which will be described later, and the term “liquid-phase carbonization” as used herein is not necessarily the same as carbonization by heating in an inert gas atmosphere under typical carbonization conditions as is generally used.

In the present invention, the carbon-containing material is carbonized with its surfaces coated with a proto-shaped mold as described later. It is, therefore, considered that since thermally decomposed gases are confined to cause a decrease in the melt viscosity of the carbon-containing material, a carbon-containing material, such as a thermosetting polymer, which would usually undergo solid-phase carbonization can undergo liquid-phase carbonization. Thus, in the present invention, the term “materials which undergo liquid-phase carbonization” refers to materials which can be melted under the cover of a proto-shaped mold and can undergo a liquid-phase carbonization process in a broad sense. Therefore, what is called a thermosetting polymer may be usable for the purpose of the present invention as one of “materials which undergo liquid-phase carbonization.”

Specific examples of the materials which undergo liquid-phase carbonization include pitch, polyacrylonitrile and its copolymers, polyvinyl alcohol, polyvinyl chloride, phenol resin, and rayon. Of these, polyacrylonitrile and its copolymers are preferred.

The term “readily decomposable polymer” as used herein is intended to refer to a polymer which usually decomposes when heated to 500° C. or higher in an inert atmosphere under ambient pressure. Specific examples of the readily decomposable polymer include polycarbonate, polystyrene, polymethyl acrylate, polymethyl methacrylate, polyethylene, and polypropylene. Of these, polycarbonate, polystyrene and polymethyl methacrylate are preferred. These polymers, which are not usually used as ingredients of a carbon structural body, can be carbonized in the production method of the present invention contrary to expectations, presumably because the precursor body is carbonized with its surface coated with a proto-shaped mold of a heat-resistant material as described later.

The carbon-containing materials may be used singly or in combination of two or more thereof in any proportion. Of these, the use of one or at least two of the materials which undergo liquid-phase carbonization and/or the readily decomposable polymers is preferred, and the use of one or at least two of the materials which undergo liquid-phase carbonization is particularly preferred.

The above description is given only for the purpose of illustrating the general principles, and the type of the specific appropriate carbon-containing material is dependent on the intended pattern of the carbon structural body to be produced (in other words, the pattern of the precursor body). Thus, the type of the carbon-containing material to be used should be preferably selected based on the intended pattern of the carbon structural body.

The carbon-containing material will be described in further detail below.

The carbon-containing material is not particularly limited as long as it undergoes liquid-phase carbonization during the carbonization process, which will be described later. Specific examples of the carbon-containing material include pitch and synthetic high molecular weight compounds. Examples of the synthetic high molecular weight compounds include polyacrylonitrile and its copolymers, polyvinyl alcohol, polyvinyl alcohol, a phenol resin, polycarbonate, and polystyrene and its copolymers. Particularly, the synthetic high molecular weight compounds are preferred.

Specific examples of the monomer as a constituent of the synthetic high molecular weight compounds are as follows. Examples of the monomer which can be polymerized by radical polymerization include: polymerizable unsaturated aromatic compounds such as styrene, chlorostyrene, α-methylstyrene, divinylbenzene and vinyl toluene; polymerizable unsaturated carboxylic acids such as (meth)acrylic acid, itaconic acid, maleic acid and phthalic acid; polymerizable unsaturated sulfonic acids such as styrenesulfonic acid and sodium styrenesulfonate; polymerizable carboxylic acid esters such as methyl (meth)acrylate, ethyl (meth)acrylate, n-butyl (meth)acrylate, 2-hydroxyethyl (meth)acrylate, hydroxylpropyl (meth)acrylate, glycidyl (meth)acrylate, N-(meth)acryloyloxysuccinimide, ethylene glycol di(meth)acrylate, tribromophenyl (meth)acrylate, 2-glycosyloxyethyl (meth)acrylate and 2-methacryloyloxyethyl phosphorylcholine; unsaturated carboxylic amides, polymerizable unsaturated nitriles, halogenated vinyls and conjugated dienes such as (meth)acrylonitrile, (meth)acrolein, (meth)acrylamide, N,N-dimethylacrylamide, N-isopropyl(meth)acrylamide, N-vinylformamide, 3-acrylamide phenylboronic acid, N-acryloyl-N′-biotinyl-3,6-dioxaoctane-1,9-diamine, butadiene, isoprene, vinyl acetate, vinylpyridine, N-vinyl pyrrolidone, N-(meth)acryloylmorpholine, vinyl chloride, vinylidene chloride and vinyl bromide; and macromonomers such as polyethylene glycol mono(meth)acrylate and polypropylene glycol mono(meth)acrylate.

Monomers which can be polymerized by addition polymerization can be also used. Specific examples of such monomers include aliphatic or aromatic isocyanates such as diphenylmethane diisocyanate, naphthalene diisocyanate, tolylene diisocyanate, tetramethylxylene diisocyanate, xylene diisocyanate, dicyclohexene diisocyanate, dicyclohexylmethane diisocyanate, hexamethylene diisocyanate and isophorone diisocyanate, ketenes, epoxy group containing compounds and vinyl group containing compounds.

The synthetic high molecular weight compound may optionally contain, in addition to the monomers as described above, a polyfunctional compound which can function as a cross-linking agent. Specific examples of the polyfunctional compound include N-methylol acrylamide, N-ethanol acrylamide, N-propanol acrylamide, N-methylol maleimide, N-ethylol maleimide, N-methylol-maleinamic acid, N-methylol maleinamic acid esters, N-alkylol amides of a vinyl aromatic acid (such as N-methylol-p-vinyl benzamide) and N-(isobutoxymethyl) acrylamide.

Specific examples of hydrophilic monomers include (meth)acrylic acid, itaconic acid, 2-hydroxy ethyl (meth)acrylate, 2-hydroxypropyl (meth)acrylate, maleic acid, sulfonic acid, sodium sulfonate, (meth)acrylamide, N,N-dimethyl(meth)acrylamide, N-isopropylacrylamide, N-vinylformamide, (meth)acrylonitrile, N-(meth)acryloyl morpholine, N-vinylpyrrolidone, N-vinylacetamide, N-vinyl-N-acetamide, polyethylene glycol mono(meth)acrylate, glycidyl (meth)acrylate and 2-methacryloxyethyl phosphorylcholine.

When a synthetic high molecular weight compound is synthesized by radical polymerization of a monomer, a radical polymerization initiator is usually mixed to initiate the polymerization reaction. As the radical polymerization initiator for use at that time, any initiator can be used as long as the effects of the present invention are not seriously adversely affected. Examples of the usable radical polymerization initiator include azo(azobisnitrile) type initiators such as 2,2-azobis(isobutyronitrile), 2,2-azobis-(2-methylpropanenitrile), 2,2′-azobis-(2,4-dimethylpentanenitrile), 2,2-azobis-(2-methylbutanenitrile), 1,1′-azobis-(cyclohexanecarbonitrile), 2,2′-azobis-(2,4-dimethyl-4-methoxyvaleronitrile), 2,2′-azobis-(2,4-dimethylvaleronitrile), 2,2′-azobis-(2-amidinopropane) hydrochloride; and peroxide type initiators such as benzoyl peroxide, cumene hydroperoxide, hydrogen peroxide, acetyl peroxide, lauroyl peroxide, persulfates (e.g. ammonium persulfate) and ester peroxides (e.g., t-butyl peroctate, α-cumyl peroxypivalate and t-butyl peroctate).

A redox-type initiator may be also used to initiate the polymerization reaction. Any redox-type initiator can be used as long as the effects of the present invention are not seriously adversely affected. Suitable examples of the redox type initiator include ascorbic acid, iron (II) sulfate, sodium peroxydisulfate, tertiary butyl hydroperoxide, sodium disulfite, tertiary butyl hydroperoxide and sodium hydroxymethane sulfinate. Each component, for example, the reduction component, may be a mixture, such as a mixture of a sodium salt of hydroxymethane sulfinic acid and sodium disulfite.

As the synthetic high molecular weight compound, a polymer which can be synthesized by ring-opening polymerization may be also used. One specific example of such a compound is polyethylene glycol.

Further, as the synthetic high molecular weight compound, a polymer which can be synthesized by hydrolysis or other method may be used. One specific example of such a compound is polyvinyl alcohol obtained by hydrolysis of polyvinyl acetate.

### I-2. Formation of Shaped Carbon-Containing Material (Preparation of Precursor Body)

In the production method of the present invention, the carbon-containing material as described above is formed into a desired pattern to obtain a precursor body. The term “pattern” as used herein is intended to refer to a shape with a regularity. The regularity may be provided all over or in some areas of the shape. The regularity may be a two-dimensional (planar) regularity or a three-dimensional (stereo) regularity. The term “regularity” as used herein is intended to refer to an arrangement in which a similar shape is repeatedly formed in a cyclical fashion or a constant shape is repeated at regular intervals or repeatedly presented. In the present invention, the pattern of the precursor body formed from the carbon-containing material is reflected to the pattern of the resulting carbon structural body with virtually no change. Major examples of the method for forming the carbon-containing material into a pattern include a nanoimprint method, a soft lithography method and a self-assembly method. These methods may be used singly or in combination of two or more thereof.

The pattern of the precursor body (that is, the pattern of the carbon structural body resulting therefrom) is not particularly limited, and any pattern may be employed as long as it can be formed. Typical examples of the pattern include the following (i) to (iii).

(i) A shape having voids defined by carbon walls and a surface with a plurality of fine pores regularly formed therein. The shape of the fine pores is not particularly limited, and the fine pores may be formed in various shapes. There are two types: a type where the fine pores are through-holes (this type may be hereinafter referred to as “honeycomb type.”) and a type where the fine pores are non-through-holes. The non-through-hole type is further divided into two types: a type where the fine pores have a semispherical shape (this type may be hereinafter referred to as “dimple type”) and a type where the fine pores have a shape other than semispherical (this type may be hereinafter referred to as “projection/recess type”).

In the present invention, the shape of the “fine pore” is not particularly limited. For example, the fine pore may have a square shape with sides having a dimension of 10 nm to several microns. The term “through-hole” as used herein is intended to refer to a fine pore which substantially extends through at least a part of the carbon structural body, and the term “non-through-hole” as used herein is intended to refer to a fine pore which does not substantially extend through at least a part of the carbon structural body. The term “hole” used in this specification is intended to refer not only to “through-hole” of the honeycomb-type pattern but also more broadly to a fine pore including the “semispherical pore” of the dimple-type pattern, which will be described later, and various types of non-through-hole of a porous pattern. The term “diameter” as used herein is intended to refer, in the case of a circular fine pore, to the diameter of the maximum circle inscribed in the opening of the fine pore. When the shape of a fine pore is substantially circular, the “diameter” means the diameter of the circle. When the shape of a fine pore is substantially ellipsoidal, the “diameter” means the length of the minor axis of the ellipse.

(ii) A shape having voids defined by carbon walls and a surface with a plurality of fine projections regularly formed thereon (this type may be hereinafter referred to as “fine projection type”).

(iii) A shape formed by a plurality of particles having voids defined by carbon walls and bonded together (this type may be hereinafter referred to as “colloid crystal type”).

The above patterns (i) to (iii) are schematic description of the shape of the precursor body or carbon structural body. In reality, there are a pattern having properties between two of the above patterns and a pattern having properties of a plurality of the above patterns. In addition, the above patterns are only typical examples. Therefore, the patterns into which the carbon-containing material is formed (that is, the patterns of the precursor body or carbon structural body) in the present invention are not limited the above specific patterns.

Specific examples of the methods for preparing precursor bodies having the above typical patterns will be described in detail below. The following description is given for the purpose of illustration, and the methods for forming the patterns are not limited to the following methods in any way.

a. Self-Assembly (Preparation of Honeycomb-Type Precursor Body)

A precursor body having a honeycomb-type pattern (which will be hereinafter referred to as “honeycomb-type precursor” as needed) can be prepared by self-assembly, for example.

More specifically, an amphiphilic polymer is used as the carbon-containing material. The amphiphilic polymer is dissolved in a hydrophobic organic solvent, and the obtained solution is casted on a substrate. Evaporation of the organic solvent and condensation of water vapor on the surface of the casted film are simultaneously brought about, and the fine water droplets formed by the condensation are evaporated. Then, the water droplets formed by the condensation serve as a mold, so that a honeycomb-type precursor body can be obtained.

A polymer is used as the carbon-containing material. As the polymer, at least an amphiphilic polymer is used as described above. An amphiphilic polymer alone may be used, but an amphiphilic polymer may be used together with another polymer (other than an amphiphilic polymer).

Suitable examples of the amphiphilic polymer include a polylactic acid-polyethylene glycol block copolymer, a poly(ε-caprolactone)-polyethylene glycol block copolymer and a polymalic acid-polyalkyl malate block copolymer. As suitable amphiphilic polymers, there may also be mentioned a polyethylene glycol/poly propylene glycol block copolymer; an amphiphilic polymer having a main chain skeleton of an acrylamide polymer and containing a dodecyl group as a hydrophobic-side chain and a lactose group or a carboxyl group as a hydrophilic-side chain; an ion complex of an anionic polymer, such as heparin, dextran sulfate or a nucleic acid (DNA or RNA), and a long-chain alkyl ammonium salt; and an amphiphilic polymer containing a water-soluble protein, such as gelatin, collagen or albumin, as a hydrophilic group. These amphiphilic polymers may be used singly or in combination of two or more thereof in any proportion.

An amphiphilic polymer is used together with another polymer (other than an amphiphilic polymer). In this case, it is preferred that “another polymer” be, for example, an aliphatic polyester such as polylactic acid, poly(hydroxybutyric acid), polycaprolactone, polyethylene adipate or polybutylene adipate; an aliphatic polycarbonate such as polybutylene carbonate or polyethylene carbonate; polystyrene; or polymethyl methacrylate from the standpoint of solubility in an organic solvent. These polymers (other than an amphiphilic polymer) may be used singly or in combination of two or more thereof in any proportion.

In preparing a honeycomb-type precursor body by this method, it is necessary that the organic solvent to be used should be a non-water-soluble (hydrophobic) since fine water droplets must be formed on the polymer solution as described before. Suitable examples of the hydrophobic organic solvent include halogen-based organic solvents such as chloroform and methylene chloride; aromatic hydrocarbons such as benzene, toluene and xylene; esters such as ethyl acetate and butyl acetate; non-water-soluble ketones such as methyl isobutyl ketone; and carbon disulfide. These organic solvents may be used singly or in combination of two or more thereof in any proportion.

The concentration of the polymer dissolved in the hydrophobic organic solvent is generally 0.01% by weight or higher, preferably 0.05% by weight or higher, and generally 10% by weight or lower, preferably 5% by weight or lower. Too low a polymer concentration is undesirable since the resulting film cannot have sufficient mechanical strength. When the polymer concentration is too high, on the other hand, a honeycomb structure is not properly formed. When two or more polymers are used together, the total concentration of the polymers must be within the above range.

When an amphiphilic polymer and another polymer (other than an amphiphilic polymer) are used together, the relative proportion of the polymers is not particularly limited but the ratio of {weight of amphiphilic polymer}:{weight of another polymer (other than an amphiphilic polymer)} is generally 0.1:99.9 or higher (0.1•:•99.9, total=100), preferably 1:99 or higher (1•:•99, total=100), and generally 50:50 or lower (•50:50•, total=100), preferably 10:90 or lower (•10:90•, total=100). When the proportion of the amphiphilic polymer is excessively low, a uniform honeycomb structure may not be formed. When the proportion of the amphiphilic polymer is excessively high, on the other hand, the resulting precursor bodies or carbon structural bodies may have low stability, low mechanical stability, in particular.

The polymer is dissolved in the hydrophobic organic solvent in the above conditions, and the obtained solution (which will be hereinafter referred to simply as “polymer solution” as needed) is casted on a substrate. Although the material of the substrate is not particularly limited, the use of a substrate made of an inorganic material such as glass, metal or silicon wafer or a high molecular weight compound having high resistance against organic solvents such as polypropylene, polyethylene and polyether ketone is preferred. Although the shape of the substrate is not particularly limited, since the shape of the surface on which the polymer solution is to be applied determines the shape of the precursor body, therefore the shape of the carbon structural body, the shape of the substrate should be preferably selected based on the intended shape of the resulting carbon structural body. In general, the use of a substrate having a flat or a generally flat surface on which the polymer solution can be applied is preferred

The mechanism by which a honeycomb-type pattern is formed is believed to be as follows. When the hydrophobic organic solvent evaporates, it absorbs latent heat and lowers the surface temperature of the casted film to cause water vapor condense into fine water droplets on the surface of the polymer solution. Then, the surface tension between the water and the hydrophobic organic solvent is decreased by the action of the hydrophilic portions in the polymer solution. Thus, the water droplets tend to agglomerate into a large mass and are stabilized. As the hydrophobic organic solvent evaporates, the water droplets are arranged in the hexagonal close pack alignment. Then, when the water is eventually evaporated, there remains a structure in which the molecules of the polymer are regularly arranged in a honeycomb fashion.

Thus, it is preferred that the honeycomb-type precursor body be prepared by one of the following methods:

(1) a method including the steps of: casting a polymer solution on a substrate; blowing high-humidity air onto the polymer solution to cause gradual evaporation of the hydrophobic organic solvent and condensation of water vapor on the casted liquid surface simultaneously; and evaporating the fine water droplets formed by the condensation; and
(2) a method including the steps of: casting a polymer solution on a substrate in air with a relative humidity of 50 to 95%; causing evaporation of the hydrophobic organic solvent and condensation of water vapor on the casted liquid surface simultaneously; and evaporating the fine water droplets formed by the condensation.

The honeycomb-type precursor body obtained by the above method have a surface with a plurality of through-holes regularly defined therethrough. The number of the through-holes is not particularly limited as long as the precursor bodies have a plurality of through-holes, although it depends on various conditions. The density of the through-holes is not particularly limited either. The precursor body has a void ratio of generally 1% or higher, preferably 10% or higher, and generally 99% or lower, preferably 90% or lower. When the void ratio is excessively high, the strength of the precursor body may be insufficient. When the void ratio is excessively low, on the other hand, the quality of the precursor body will not be substantially different from that of a flat membrane without holes. The manner of arrangement of the through-holes is not particularly limited either. The through-holes are usually arranged in one or plurality of arrays at generally regular intervals. The through-holes are not necessarily arranged regularly in a narrow sense but need to be arranged with a regularity required by the particular application of the resulting carbon structural body.

The regularity of the through-holes can be expressed by the value (%) obtained by dividing the difference between the maximum and minimum values of the distances from the center or center of gravity of the shape of the opening of one hole to those of adjacent holes measured for at least six holes by the average of the distances between the centers of gravity. In general, when the value is 30% or lower, preferably 20% or lower, the precursor body may be referred to as having a regularly arranged structure. The distances between through-holes can be analyzed on a scanning electron microscope photograph taken at a magnification of at least 2,000 times.

The shape of the opening of individual through-holes of the honeycomb-type precursor body is not particularly limited, and the openings may be of any shape such as circular, ellipsoidal, square, rectangular or hexagonal. The average of the diameters of the through-holes is not particularly limited either, but is generally 0.1 μm or greater, preferably 0.5 μm or greater, and generally 20 μm or smaller, preferably 10 μm or smaller.

In addition, it is preferred that the through-holes have a generally uniform diameter from the viewpoint of regularity. The regularity can be expressed by the value (%) obtained by dividing the difference between the maximum and minimum values of the diameters measured for at least six holes by the average of the diameters. The value is generally 30% or lower, preferably 20% or lower.

The term “diameter” as used herein is intended to refer to the diameter of the maximum circle inscribed in the opening of the hole. For example, when the shape of the opening of the hole is substantially circular, the “diameter” means the diameter of the circle. When the shape of the opening of the hole is substantially ellipsoidal, the “diameter” means the dimension of the minor axis of the ellipse. When the shape of the opening of the hole is substantially square, the diameter means the dimension of the side of the square. When the shape of the opening of the hole is substantially rectangular, the diameter means the length of the short side of the rectangle. The term “hole” as used in this specification is intended to refer not only to “through-hole” of the honeycomb-type pattern but also more broadly to a fine pore including the “semispherical pore” of the dimple-type pattern, which will be described later, and various types of non-through-hole of a porous pattern.

The shape of the honeycomb-type precursor body is not particularly limited, but the honeycomb-type precursor body usually has a film- or sheet-like shape derived from the shape of the casted film. The size of the honeycomb-type precursor body is not particularly limited either, but the honeycomb-type precursor body has a major axis with a length of generally 1 μm or greater, preferably 5 μm or greater, and generally 1 mm or smaller, preferably 100 μm or smaller as views in a plan view. The thickness of the honeycomb-type precursor body is not particularly limited, but the honeycomb-type precursor body has a thickness of generally 0.1 μm or greater, preferably 0.5 μm or greater, and generally 100 μm or smaller, preferably 20 μm or smaller.

b. Split (Preparation of Fine Projection-Type Precursor Body)

A precursor body having a fine projection-type pattern (which will be hereinafter referred to as “fine projection-type precursor body” as needed) can be prepared by splitting a honeycomb-type precursor body prepared by a self-assembly method as described above, for example.

More specifically, an adhesive tape is attached to honeycomb-type precursor body prepared by the above method and the honeycomb-type precursor body is split into halves by peeling the adhesive tape or other means. Then, honeycomb-type precursor body having a surface on which fine projections formed by splitting the honeycomb structure are regularly arranged can be obtained.

The shape and size of the fine projections of the fine projection-type precursor body prepared by the above method are not particularly limited, but the fine projections generally have a length of about 0.1 μm or greater and about 50 μm or smaller and a tip thickness of about 0.01 μm or greater and about 20 μm or smaller, and are spaced at intervals of 0.1 μm or greater and about 100 μm or smaller.

The regularity of the intervals between the projections can be expressed by the value (%) obtained by dividing the difference between the maximum and minimum values of the distances from the tip or the center of the base of one projection to those of adjacent projections measured for at least six projections by the average of the distances. In general, when the value is 30% or lower, preferably 20% or lower, the precursor body may be referred to as having a regularly arranged structure. The distances between the through-holes can be analyzed on a scanning electron microscope photograph taken at a magnification of at least 2,000 times.

In addition, it is preferred that the projections have a generally uniform length from the viewpoint of regularity. The regularity of the length can be expressed, as in the case with the regularity of the interval, by the value (%) obtained by dividing the difference between the maximum and minimum values of the lengths measured for at least six projections by the average of the lengths. The value is generally 30% or lower, preferably 20% or lower.

The thickness of the fine projection-type precursor body is not particularly limited, but the fine projection-type precursor body has a thickness of generally 0.1 μm or greater, preferably 0.5 μm or greater, and generally 100 μm or smaller, preferably 20 μm or smaller.

c. Pattern Transfer (Preparation of Dimple-Type Precursor Body, Projection/Recess-Type Precursor Body, Etc.)

A precursor body having a dimple-type pattern (which will be hereinafter referred to as “dimple-type precursor body”) and a precursor body having a projection/recess-type pattern (which will be hereinafter referred to as “projection/recess-type precursor body”) can be prepared by a pattern transfer process using a honeycomb-type precursor body prepared by the above self-assembly method as a mold or using a mold having a pattern formed by a nanoimprint method, which will be described later. When the conditions of the pattern transfer process are properly adjusted or another pattern transfer process is performed using a structure obtained by a pattern transfer process as a mold, a honeycomb-type precursor body or a fine projection-type precursor body as described above can be also prepared. The method of pattern transfer will be first described below, and the methods for preparing a dimple-type precursor body and a projection/recess-type precursor body by pattern transfer will be described next.

c-1. Method Of Pattern Transfer

The method of pattern transfer is not particularly limited, and any method can be employed as long as the pattern of a mold (which will be hereinafter referred to as “mold pattern” as needed) can be transferred to the material to which the mold pattern is to be transferred (which will be hereinafter referred to as “transferring material” as needed). Specific examples of the method of pattern transfer include, but are not limited to, the following methods.

### Direct Pattern Transfer:

A mold pattern can be transferred to a transferring material by applying a solution of a transferring material or a transferring material itself to a mold, curing the transferring material by drying or applying light or heat, and removing or dissolving the mold. By applying a surface treatment to the mold or controlling the type of surface treatment, shapes complementary to the shapes of the mold pattern, such as projections to recesses or recesses to projections, can be formed and shapes different from the shapes of the mold pattern can be formed. For example, when a dimple-type precursor body is prepared using a honeycomb-type precursor body as a mold as described later and when pattern transfer is performed without applying any surface treatment to the honeycomb-type precursor body, the pattern transferring material cannot enter the holes of the honeycomb-type pattern because of air therein and, hence, the shapes of the holes of the honeycomb-type pattern are not transferred but semispherical holes are formed. When a suitable surface treatment is applied to the honeycomb-type precursor body, the shape of the honeycomb-type pattern serve as a mold and a projection-type pattern complementary to the honeycomb-type pattern can be formed.

In the direct pattern transfer process, when the interface energy between the materials is controlled and conditions under which the material of the mold is not eluted or deformed are selected, any transferring material can be used. When the transferring material is carbonized into carbon structural body after a direct pattern transfer process, a carbonizable material, such as a versatile polymer, an engineering plastic, organic fine particles, biodegradable or biocompatible material, thermosetting material, a water shedding material (e.g. fluororesin), or a high molecular weight material such as gel, and materials which are polymerized or crystallized when exposed to light or heat can be used. When another pattern transfer process is performed using the transferring material after a direct transfer process as a mold as described later, inorganic fine particles and inorganic oxides prepared by a sol-gel method, in addition to the above carbonizable materials, can be used.

### Pattern Inducing Crystallization:

This is a method in which a pattern is transferred while a transferring material is being crystallized. A solution of a transferring material to be crystallized is applied to a mold. Alternatively, a mold and a substrate are placed with a small gap therebetween and a solution of a transferring material to be crystallized is injected into the gap. Then, the solvent is evaporated to cause fine crystals of the transferring material to grow. As a result, crystal arrays of the transferring material to which the mold pattern has been transferred can be formed. In the pattern inducing crystallization, the use of a low molecular weight compound having a high crystallization rate as the transferring material is preferred. Suitable examples of such compound include organic or inorganic pigments and salts. Also, by controlling the mold pattern and its size, the size and shape of the resulting crystals can be controlled.

### Pattern Transfer by Lithography:

A mold pattern is transferred to a transferring material by lithography. Although the method involves a multistep process, a lithography technology, which has been already established, can be used. One suitable example of the transferring material for use in pattern transfer by lithography is a resist agent. By performing etching or the like after the pattern has been transferred to a resist agent, a semiconductor or inorganic material can be formed into a pattern.

### Multistep Process:

In the present invention, when the pattern transfer process is repeated a plurality of times using a transferred pattern as a mold, a structure similar to or complementary to that of the original mold can be formed using a variety of materials. Also in this case, by applying a suitable surface treatment to the mold, or by controlling the type of the surface treatment or the number of times of pattern transfer processes, the mold pattern can be transferred to the transferring material without virtually no change. It is also possible to form shapes complementary to the shapes of the mold pattern, such as projections to recesses or recesses to projections. It is further possible to form shapes different from the shape of the mold pattern. When a pattern transfer process is repeated a plurality of times, it is preferable to use a material which has high strength and does not mix with other materials easily, such as cross-linked resin, as an in-process material to which a pattern is transferred. But the present invention is not limited to the above.

c-2. Preparation Of Dimple-Type Precursor Body

A precursor body having a dimple-type pattern (which will be hereinafter referred to as “dimple-type precursor body” as needed) can be prepared by transferring the pattern of a honeycomb-type precursor body prepared by the above self-assembly method as a mold to a pattern transferring material. More specifically, since the pattern transferring material cannot enter the holes of the honeycomb-type pattern because of air therein, the shapes of the holes of the honeycomb-type pattern are not transferred but hemispherical holes are formed.

The type of the pattern transferring material (which is the material of the dimple-type precursor body here) is not particularly limited as long as it is a carbon-containing material. Although the use of a material which is incompatible with the material of the honeycomb-type precursor body is preferred, a material which is compatible with the material of the honeycomb-type precursor body can also be used when an interface control is performed. The method of pattern transfer is not particularly limited, and any of the methods described above can be selected.

The shape of the resulting dimple-type precursor body is not particularly limited as long as each hole has a generally semispherical shape. The shape of the openings of the holes is not particularly limited either, and the openings may be of any shape such as circular, ellipsoidal, square, rectangular or hexagonal. The average of the diameters of the holes is not particularly limited, but is generally 0.1 μm or greater, preferably 0.5 μm or greater, and generally 20 μm or smaller, preferably 10 μm or smaller. The physical properties of the holes, such as diameter and shape, can be controlled by properly adjusting the shape of the mold pattern or transfer conditions.

The regularity of arrangement of the holes can be expressed by the value (%) obtained by dividing the difference between the maximum and minimum values of the distances from the center or center of gravity of the opening of one hole to those of adjacent holes measured for at least six holes by the average of the distances between the centers of gravity. In general, when the value is 30% or lower, preferably 20% or lower, the precursor body may be referred to as having a regularly arranged structure. The distances between the openings can be analyzed on a scanning electron microscope photograph taken at a magnification of at least 2,000 times. In addition, it is preferred that the holes have a generally uniform diameter from the viewpoint of regularity. The regularity can be expressed by the value (%) obtained by dividing the difference between the maximum and minimum values of the diameters measured for at least six holes by the average of the diameters. The value is generally 30% or lower, preferably 20% or lower.

The overall shape of the dimple-type precursor body is not particularly limited, but the dimple-type precursor body usually has a film- or sheet-like shape corresponding to the method of pattern transfer. The size of the dimple-type precursor body is not particularly limited either, but the dimple-type precursor body haw a major axis with a length of generally 1 μm or greater, preferably 5 μm or greater, and generally 1 mm or smaller, preferably 100 μm or smaller as views in a plan view. The thickness of the dimple-type precursor body is not particularly limited, but the dimple-type precursor body has a thickness of generally 0.1 μm or greater, preferably 0.5 μm or greater, and generally 100 μm or smaller, preferably 20 μm or smaller.

c-3. Preparation of Projection/Recess-Type Precursor Body

A precursor body having a projection/recess-type pattern (which will be hereinafter referred to as “projection/recess-type precursor body” as needed) is a precursor body which has non-through-holes and has a shape other than a semispherical shape, that is, a precursor body which has non-through-holes but does not fall under the category of “dimple-type precursor body.”

The production method is not particularly limited, but a nanoimprint technology, for example, can be used. For example, a method in which an Si mold having a projection/recess pattern is pressed against a liquid polymer on a substrate to transfer the pattern thereto can be used.

A soft lithography method called microcontact print can be also used. This method includes the steps of molding a polymer such as resist material on a surface of a PDMS (polydimethylsiloxane) stamp with a projection/recess pattern; pressing the stamp against a substrate to transfer the molded polymer onto the substrate; and heating the substrate to form the polymer into a precursor having a pattern.

The shape of the resulting projection/recess-type precursor body is not particularly limited. The shape of individual openings is not particularly limited either, and the openings may be of any shape such as circular, ellipsoidal, square, rectangular or hexagonal. The average of the diameters of the openings is not particularly limited, but is generally 0.1 μm or greater, preferably 0.5 μm or greater, and generally 20 μm or smaller, preferably 10 μm or smaller. The physical properties of the holes, such as diameter and shape, can be controlled by properly adjusting the shape of the mold pattern or transfer conditions.

The overall geometry of the projection/recess-type precursor body is not particularly limited, but the projection/recess-type precursor body usually has a film- or sheet-like shape corresponding to the method of pattern transfer. The size of the projection/recess-type precursor body is not particularly limited either, but the projection/recess-type precursor body has a major axis with a dimension of generally 1 μm or greater, preferably 5 μm or greater, and generally 1 mm or smaller, preferably 100 μm or smaller as views in a plan view. The thickness of the projection/recess-type precursor body is not particularly limited, but the projection/recess-type precursor body has a thickness of generally 0.1 μm or greater, preferably 0.5 μm or greater, and generally 100 μm or smaller, preferably 20 μm or smaller.

d. Colloid Crystal Method (Preparation of Colloid Crystal-Type Precursor Body)

A precursor body having a colloid crystal-type pattern (which will be hereinafter referred to as “colloid crystal-type precursor body” as needed) is a precursor body in which colloid particles of a carbon-containing material (which will be hereinafter referred to as “colloid precursor particles” as needed) having generally uniform particle size are bonded to each other in a cyclical arrangement.

The colloid precursor particles can be prepared by the following method using a synthetic high molecular weight compound as described before as the carbon-containing material. A monomer of a polymer which can form a liquid phase such as acrylonitrile is subjected to emulsion polymerization, miniemulsion polymerization, soap-free polymerization, suspension polymerization, dispersion polymerization, precipitation polymerization or the like polymerization with or without a copolymerizable monomer as needed to obtain particles of polyacrylonitrile, its copolymer or the like polymer having uniform particle size as an emulsion. The copolymerizable monomer may be a monomer selected from the group of monomers of readily decomposable polymers. Another example of the method for preparing colloid precursor particles having a very uniform particle size is a method in which a monomer of polymers which can form a liquid phase such as acrylonitrile is added to particles of a readily decomposable polymer obtained by soap-free polymerization. Then two-step soap-free polymerization is carried out to obtain uniform particles having a core shell structure as an emulsion.

The colloid precursor particles in the emulsion obtained by such a polymerization method are obtained as aggregates of particles generally having a particle size in the range of 5 nm to 100 μm and very narrow particle size distribution.

The colloid crystal-type precursor body is typically composed of at least thirty colloid precursor particles aggregated and bonded together. To form such a colloid crystal-type precursor body, the colloid precursor particles are dried to obtain a colloid crystal of the colloid precursor particles. Then, the colloid crystal is heated to stabilize the state of the colloid crystal. For example, when the carbon-containing material for the colloid precursor particles is a polymer, the colloid crystal is heated to a temperature higher than the glass transition point of the polymer so that the colloid precursor particles can be fusion-bonded to each other.

1-3. Coating with Proto-Shaped Mold

Next, the precursor body (shaped carbon-containing material body with a desired pattern) is coated with a proto-shaped mold to retain the pattern thereof. As the material for the proto-shaped mold, a heat-resistant material is usually used so that the pattern of the precursor body can be retained even when the precursor body is subjected to a carbonization process, which will be described later.

The heat-resistant material is required not to undergo thermal deformation at a temperature which is lower than a temperature range in which the precursor body is carbonized so as not to adversely affect the shape of the precursor body. As the heat-resistant material, a material which has a linear thermal contraction coefficient of 30% or lower in a temperature range of 50 to 500° C. and does not have a clear glass transition point (Tg) in a temperature range of 50 to 500° C. is preferred. Also, a material which can be removed by a simple method after the carbonization by heating is preferred.

As heat-resistant materials which have the above properties, inorganic oxides are preferred. More specifically, as the heat resistant material, there may be mentioned, for example, SiO₂, Al₂O₃, TiO₂, ZrO₂, In₂O, ZnO, PbO, Y₂O₃, BaO and mixtures thereof. Of these, SiO₂, Al₂O₃, TiO₂ and ZrO₂ are preferred in view of the purity of the resulting carbon structural body and control of metal impurities. The use of SiO₂ is particularly preferred for reasons of ensuring stable progress of the carbonization reaction of the precursor body and crystallization thereof.

As the method for coating the precursor body or bodies with a proto-shaped mold, there may be mentioned, for example, a sol-gel coating method using a metal alkoxide or the like of one of the above inorganic oxides as an ingredient, a coating method using a solution of a solvent-soluble inorganic compound such as nitrate or oxychloride salt and a method in which silica sol is mixed with the precursor bodies in a solvent such as alcohol, the obtained mixture being subsequently dried to cause the silica to adhere to surfaces of the precursor bodies.

Another example of the material which has the above properties and thus can be used in the sol-gel coating method other than the metal alkoxides is sodium silicate (water glass).

In particular, a method in which a sol solution obtained by hydrolysis of a metal alkoxide is applied to the precursor bodies or a method in which the precursor bodies are dispersed in a sol solution obtained by hydrolysis of a metal alkoxide, with the resulting precursor bodies being subsequently dried to gelate or solidify the solution around the precursor bodies is preferred since the process of homogenizing the gel can be controlled in a stable manner.

For example, a concrete method for coating the precursor bodies with SiO₂ is as follows. An alkoxysilane is added to a solution of an alcohol such as methanol or ethanol, and the mixture is stirred for several hours at room temperature to cause hydrolysis, thereby obtaining a silicate sol solution. When the sol solution is prepared, the pH of the mixture is usually adjusted to a suitable level to stabilize the sol and to control the reactivity. Thus, oxalic acid, acetic acid, hydrochloric acid, sulfuric acid, nitric acid, ammonia or the like may be added as a pH adjusting agent.

When sodium silicate is used, a sol solution may be prepared by a method in which water is to an alcohol solution of sodium silicate, instead of the above method in which sol is prepared from a metal alkoxide. The mixture is stirred together with an ion exchange resin to cause an exchange reaction between sodium and hydrogen.

Then, the precursor bodies are mixed in the sol solution, and the mixture is allowed to stand at a temperature between room temperature and 40° C. for a few hours to a few days until the solution turns into a gel to obtain a silica gel in which the precursor bodies are dispersed.

In addition to the above methods, there may be mentioned a method in which a silicate sol solution is applied to the precursor bodies by spraying.

Specific examples of the alkoxysilane includes: tetraalkoxysilanes such as tetramethoxysilane, tetraethoxysilane, tetraisopropoxysilane, tetrabuthoxysilane and their oligomers; and alkyltrialkoxysilanes such as methyltrimethoxysilane, methyltriethoxysilane, ethyltrimethoxysilane and ethyltriethoxysilane. Two or more alkoxysilanes may be conjointly used based on the conditions for the gelation process and on the dispersibility of the precursor particles during the coating process.

When the precursor bodies are coated with SiO₂, it is effective to increase the density of siloxane bonds it the SiO₂ by drying the precursor bodies coated with SiO₂, in a vacuum or by heating the precursor bodies coated with SiO₂ at a temperature at which the precursor bodies do not undergo thermal deformation for the purpose of improving the heat resistance of the coating component.

### I-4. Carbonization

Then, the precursor bodies coated with a proto-shaped mold are carbonized. The carbonization of the precursor bodies may be carried out by heating the precursor bodies coated with a proto-shaped mold in an atmosphere in which substances which can react with the precursor bodies during heating do not exist, such as nitrogen or argon.

Although the precursor bodies may be heated in a flowing atmosphere or in a sealed chamber, it is preferred that the precursor bodies be heated in a flowing atmosphere. Although the precursor bodies may be heated under an increased pressure or a reduced pressure, the precursor bodies are usually heated under ambient pressure. Although the heating temperature depends on conditions such as pressure, the heating temperature is generally 500° C. or higher, preferably 800° C. or higher, and generally 1500° C. or lower, preferably 1400° C. or lower, under ambient pressure. The temperature may be increased to a desired temperature gradually or stepwise. Although the heating period depends on conditions such as heating temperature, the precursor bodies must be held at the heating temperature for generally 0.5 hours or longer, preferably one hour or longer, and generally five hours or shorter, preferably three hours or shorter. The heating period is not necessarily continuous. That is, even if the temperature is temporarily lower than the heating temperature, no problem will occur as long as the precursor bodies are continuously held at the heating temperature and the total heating period is within the above range.

The precursor bodies undergo pyrolysis and create gas when the temperature is in a relatively high temperature range during the process of carbonization by heating, so that the melt viscosity of the precursor bodies is reduced by the pressure of the gas. The amount of gas to be generated and the melt viscosity of the precursor bodies can be controlled by appropriately selecting the type of the polymer used as the carbon-containing material, by subjecting the precursor bodies to an oxidation reaction or by controlling the porosity of the coating layer of an inorganic substance, which will be described later. It is inferred that when the amount of the pyrolysis gas is large, the gas reduces the viscosity of the molten carbon-containing material and expands the molten carbon-containing material from inside to promote formation of voids. It is, therefore, believed that the carbon-containing material is pressed against the walls of the proto-shaped mold coated on the outer surface of each of the precursor bodies by the pressure of the gas, and is carbonized at the locations. By controlling the conditions, it is possible to form a hollow structure which is large enough to be observed under an electron microscope.

### 1-5. Aftertreatment

An aftertreatment such as removal of the proto-shaped mold is usually performed after the carbonization, whereby an intended carbon structural body can be obtained.

The method for removing the proto-shaped mold can be appropriately selected depending on the material of the proto-shaped mold. For example, the proto-shaped mold may be dissolved using an aqueous alkaline solution, such as an aqueous sodium hydroxide solution, or hydrofluoric acid. The method in which the proto-shaped mold is dissolved using an aqueous alkaline solution is preferred since this method is industrially safe. In this case, the specific procedure is as follows. In general, at least 200% by weight, preferably at least 1000% by weight of an aqueous alkaline solution with a concentration of about 4 to 20 g/L is used per 100% by weight of the carbon structural bodies coated with a proto-shaped mold obtained as a result of the carbonization. The aqueous alkaline solution and the carbon structural bodies are charged in a pressure-resistant airtight container. The container is sealed and heated to generally 80° C. or higher, preferably to 100° C. or higher to dissolve the proto-shaped mold (when the container is heated to a 100° C. or higher, the reaction is carried out in a heat-resistant airtight container). After that, the resulting carbon structural bodies are separated from the solution by a solid-liquid separation technique and recovered.

As other aftertreatments for the obtained carbon structural bodies, there may be mentioned surface modification.

### 1-6. Method for Controlling Hollow Spaces in Carbon Structural Bodies

For the purpose of controlling the volume of hollow spaces defined by carbon crystal walls in the resulting carbon structural bodies, there may be adopted a method in which the type of the carbon-containing material is appropriately selected, a method in which the precursor bodies coated with the proto-shaped mold are subjected to an oxidation reaction before the carbonization process, or a method in which the density of the proto-shaped mold that coats the precursor bodies is controlled. For example, the volume of the hollow spaces defined by carbon crystal walls can be increased by various methods, such as a method in which a carbon-containing material which decreases the carbonization yield of a subsequent carbonization process is selected, a method in which the oxidation conditions are made severe while selecting a carbon-containing material which is easily cross-linked by oxidation, and a method in which the density of the proto-shaped mold that coats the precursor bodies is reduced so that the volatile components produced by pyrolysis can escape during the carbonization. Also, by combining the above methods in various ways, carbon structural bodies having intended hollow spaces can be obtained.

As the carbon-containing material which decreases the carbonization yield, there may be mentioned, for example, an acrylic resin and polystyrene. However, any material which is unlikely to be cross-linked by oxidation can be used without limitation.

Examples of the carbon-containing material which is easily oxidized include, but are not limited to, polyacrylonitrile and its copolymers, polyvinyl alcohol, polyvinyl chloride and pitch.

The oxidation treatment is generally carried out by heating generally at 150° C. or higher, preferably at 180° C. or higher, and generally at 280° C. or lower, preferably at 240° C. or lower, in an air or oxygen atmosphere at ambient pressure generally for one hour or longer and 72 hours or shorter, preferably for 24 hours or shorter. It is inferred that when the oxidation treatment is carried out, the flow viscosity of the precursor bodies during liquid-phase carbonization increases and carbonization of the carbon-containing material proceeds with pyrolysis gas being confined within the carbon-containing material. As a result, the volume of the hollow spaces increases.

As the method for controlling the density of the proto-shaped mold surrounding the precursor bodies in a case where a silicate is used as the material of the proto-shaped mold, there may be mentioned, for example, a method in which the conditions for hydrolysis and drying by heating are controlled. More specifically, when the hydrolysis is carried out at a low pH level such as pH of 2 and when the drying by heating is carried out at a high temperature, a silica gel having a high density may be obtained. On the other hand, when the hydrolysis is carried out at a pH closer to neutral and when the drying by heating is carried out at a low temperature, a silica gel having a low density may be obtained.

### 1-7. Other Matters

According to the production method of the present invention described above, a carbon structural body having almost the same pattern, in other words, substantially the same pattern, as that of shaped body into which the carbon-containing material has been formed (that is, the pattern of the precursor body) (for example, a honeycomb-type pattern, a dimple type pattern, a projection/recess-type pattern, a fine projection-type pattern or a colloid crystal-type pattern) can be achieved. Thus, nanocarbon structural bodies with various shapes, in particular, regular patterns, can be produced inexpensively and efficiently.

The advantages of the production method of the present invention are described below in comparison with the prior arts described before.

As described before, in the template method disclosed in Patent Document 1 and so on, it is necessary to synthesize a mold of a mesoporous silica material such as MCM-48 or SBA-15 first. In addition, since this method uses self-assembly of a surfactant, the types of structures that can be produced are limited and, therefore, desired structural bodies are not necessarily obtained. Further, synthesis of a mesoporous silica mold is expensive and is not suitable for industrial utilization.

The solid-phase carbonization method disclosed in Patent Document 2, Non-Patent Document 1, and so on is generally accomplished by the use of a thermosetting polymer which does not form a liquid phase when heated. Since the thermosetting polymer maintains a solid phase even while undergoing pyrolysis during carbonization, the original shape in the solid phase will be the shape of the resulting carbon structural bodies with virtually no change. Therefore, the solid-phase carbonization is suitable to maintain the original polymer shape. However, the original polymer shape cannot be formed by heating since a thermosetting polymer is used as the primary ingredient. Thus, a new technology called thermal cycle nanoimprint, which has been recently developed, for example, cannot be used. The thermal cycle nanoimprint is a method for producing a nanosized pattern including the steps of: applying a thermoplastic polymer on a substrate; heating the substrate to a temperature higher than the glass transition point of the polymer to convert the polymer to a liquid state; pressing a mold such as an Si substrate against the polymer; cooling the mold and substrate to a temperature lower than the glass transition point of the polymer; and separating the mold and the substrate (Hyomen Kagaku (Journal of Surface Science Society of Japan), Vol. 25, No. 10, 2004, p. 18).

In addition, the carbon structural bodies produced from a thermosetting polymer by the solid-phase carbonization method has no macrofine pores (voids from which gas has escaped) as the carbon structural bodies produced by liquid-phase carbonization have. Thus, it is difficult to control a hollow structure using macrofine pores with a size of 50 nm or larger, for example, to decrease the weight of carbon structural bodies.

In contrast to the above methods, according to the production method of the present invention, there is no need to prepare expensive templates since a carbon-containing material formed into shaped bodies having a pattern is coated with a proto-shaped mold. Also, since a thermoplastic polymer can be used as the carbon-containing material, a desired pattern can be formed easily by applying heat. As a result, nanosized carbon structural bodies with a desired shape can be produced easily. In addition, since hollow carbon structural bodies can be produced by appropriately selecting the carbon-containing material to be used or by suitably setting the production conditions, a weight reduction of carbon structural bodies can be achieved.

### II. Carbon Structural Body

The carbon structural body of the present invention will be described next.

### II-1. Structure of Carbon Structural Body

The carbon structural body of the present invention is a carbon structural body produced by the production method of the present invention as described above or a carbon structural body having any one of the structures (i) to (iii) described below.

(i) A carbon structural body having voids defined by carbon walls and a surface with a plurality of fine pores regularly formed therein (that is, a structural body having a honeycomb-type pattern, a dimple-type pattern, a projection/recess-type pattern or the like as described before).

(ii) A carbon structural body having voids defined by carbon walls and a surface with a plurality of fine projections regularly formed thereon (that is, a structural body having a fine projection-type pattern or the like as described before).

(iii) A carbon structural body formed by a plurality of particles having voids defined by carbon walls and bonded together (that is, a structural body having a colloid crystal-type pattern or the like as described before).

The carbon structural body having any one of the structures (i) to (iii) described above may be typically produced by the production method of the present invention as described before but is not limited thereto. Also, a carbon structural body produced by the production method of the present invention typically has any one of the structures (i) to (iii) described above but is not limited thereto. In the following description, all of these structural bodies are collectively referred to as “carbon structural bodies of the present invention” unless otherwise specifically noted.

### II-2. Shape of Carbon Structural Bodies

Although the shape of the carbon structural bodies of the present invention is different dependent on the structure, the carbon structural bodies of the present invention usually have almost the same shape, in other word, substantially the same shape, as the precursor bodies from which they are produced. Description will be made of the structure of each type of carbon structural bodies in detail.

### Honeycomb-Type Carbon Structural Body:

The honeycomb-type carbon structural body has a surface with a plurality of through-holes regularly defined therethrough. The number of the through-holes of the honeycomb-type carbon structural body is not particularly limited as long as the honeycomb-type carbon structural body has a plurality of through-holes, although it depends on various conditions. The density of the through-holes is not particularly limited either. The honeycomb-type carbon structural body has a void ratio of generally 1% or higher, preferably 10% or higher, and generally 99% or lower, preferably 90% or lower. When the void ratio is excessively high, the strength of the honeycomb-type carbon structural body may be insufficient. When the void ratio is excessively low, on the other hand, the quality of the honeycomb-type carbon structural body will not be substantially different from that of a flat membrane without holes. The manner of arrangement of the through-holes is not particularly limited either. The through-holes are usually arranged in one or plurality of arrays at generally regular intervals. The through-holes are not necessarily arranged regularly in a narrow sense but need to be arranged with a regularity required by the particular application of the carbon structural bodies.

The regularity of the through-holes can be expressed by the value (%) obtained by dividing the difference between the maximum and minimum values of the distances from the center or center of gravity of the shape of the opening of one hole to those of adjacent holes measured for at least six holes by the average of the distances between the centers of gravity. In general, when the value is 30% or lower, preferably 20% or lower, the carbon structural bodies may be referred to as having a regularly arranged structure. The regularity improves the stability of the physical properties derived from the carbon structure such as the ability to control light of a specific wavelength or heat rays. The distances between through-holes can be analyzed on a scanning electron microscope or transmission electron microscope photograph taken at a magnification of at least 2,000 times.

The shape of the opening of individual through-holes is not particularly limited, and the openings may be of any shape such as circular, ellipsoidal, square, rectangular or hexagonal. The average of the diameters of the through-holes is not particularly limited either, but is generally 0.1 μm or greater, preferably 0.5 μm or greater, and generally 20 μm or smaller, preferably 10 μm or smaller.

In addition, it is preferred that the through-holes have a generally uniform diameter from the viewpoint of structural regularity. The regularity can be expressed by the value (%) obtained by dividing the difference between the maximum and minimum values of the diameters measured for at least six holes by the average of the diameters. The value is generally 30% or lower, preferably 20% or lower, more preferably 12% or lower.

The shape of the honeycomb-type carbon structural body is not particularly limited, but the honeycomb-type carbon structural body usually has a film- or sheet-like shape derived from the shape of the casted film. The size of the honeycomb-type carbon structural body is not particularly limited either, but the honeycomb-type carbon structural body has a major axis with a length of generally 1 μm or greater, preferably 5 μm or greater, and generally 1 mm or smaller, preferably 100 μm or smaller as views in a plan view. The thickness of the honeycomb-type carbon structural body is not particularly limited, but the honeycomb-type carbon structural body has a thickness of generally 0.1 μm or greater, preferably 0.5 μm or greater, and generally 100 μm or smaller, preferably 20 μm or smaller.

### Fine Projection-Type Carbon Structural Body:

The shape and size of the fine projections of the fine projection-type carbon structural body are not particularly limited, but the fine projections generally have a length of about 0.1 μm or greater and about 50 μm or smaller and a tip thickness of about 0.01 μm or greater and about 20 μm or smaller, and are spaced at intervals of 0.1 μm or greater and about 100 μm or smaller.

The regularity of the intervals between the projections can be expressed by the value (%) obtained by dividing the difference between the maximum and minimum values of the distances from the tip or the center of the base of one projection to those of adjacent projections measured for at least six projections by the average of the distances. In general, when the value is 30% or lower, preferably 20% or lower, the carbon structural body may be referred to as having a regularly arranged structure. This range is given as a preferable range from the viewpoint of electrical properties such as field emission properties. The distances between the through-holes can be analyzed on a scanning electron microscope or transmission electron microscope photograph taken at a magnification of at least 2,000 times.

In addition, it is preferred that the projections have a generally uniform length from the viewpoint of structural regularity. The regularity of the length can be expressed, as in the case with the regularity of the interval, by the value (%) obtained by dividing the difference between the maximum and minimum values of the lengths measured for at least six projections by the average of the lengths. The value is generally 30% or lower, preferably 20% or lower, more preferably 12% or lower.

The thickness of the fine projection-type carbon structural body is not particularly limited, but the fine projection-type carbon structural body has a thickness of generally 0.1 μm or greater, preferably 0.5 μm or greater, and generally 100 μm or smaller, preferably 20 μm or smaller.

### Dimple Type Carbon Structural Body:

The holes of the dimple type carbon structural body have a generally semispherical shape. The shape of the openings of the holes is not particularly limited, and the openings may be of any shape such as circular, ellipsoidal, square, rectangular or hexagonal. The average of the diameters of the holes is not particularly limited, but is generally 0.1 μm or greater, preferably 0.5 μm or greater, and generally 20 μm or smaller, preferably 10 μm or smaller. The physical properties of the holes, such as diameter and shape, can be controlled by properly adjusting the shape of the mold pattern or transfer conditions.

The regularity of arrangement of the holes can be expressed by the value (%) obtained by dividing the difference between the maximum and minimum values of the distances from the center or center of gravity of the opening of one hole to those of adjacent holes measured for at least six holes by the average of the distances between the centers of gravity. In general, when the value is 30% or lower, preferably 20% or lower, the carbon structural body may be referred to as having a regularly arranged structure. The regularity improves the stability of the physical properties derived from the carbon structure such as the ability to control the scattering of light of a specific wavelength or heat rays. The distances between the openings can be analyzed on a scanning electron microscope photograph taken at a magnification of at least 2,000 times.

In addition, it is preferred that the holes have a generally uniform diameter from the viewpoint of regularity. The regularity can be expressed by the value (%) obtained by dividing the difference between the maximum and minimum values of the diameters measured for at least six holes by the average of the diameters. The value is generally 30% or lower, preferably 20% or lower.

The overall geometry of the dimple-type carbon structural body is not particularly limited, but the dimple-type carbon structural body usually has a film- or sheet-like shape corresponding to the method of pattern transfer. The size of the dimple-type carbon structural body is not particularly limited either, but the dimple-type carbon structural body has a major axis with a length of generally 1 μm or greater, preferably 5 μm or greater, and generally 1 mm or smaller, preferably 100 μm or smaller as views in a plan view. The thickness of the dimple-type carbon structural body is not particularly limited, but the dimple-type carbon structural body has a thickness of generally 0.1 μm or greater, preferably 0.5 μm or greater, and generally 100 μm or smaller, preferably 20 μm or smaller.

### Projection/Recess-Type Carbon Structural Body

The shape of individual openings of the projection/recess-type carbon structural body is not particularly limited, and the openings may be of any shape such as circular, ellipsoidal, square, rectangular or hexagonal. The average of the diameters of the openings is not particularly limited, but is generally 0.1 μm or greater, preferably 0.5 μm or greater, and generally 20 μm or smaller, preferably 10 μm or smaller. The physical properties of the holes, such as diameter and shape, can be controlled by properly adjusting the shape of the mold pattern or transfer conditions.

The overall geometry of the projection/recess-type carbon structural body is not particularly limited, but the projection/recess-type carbon structural body usually has a film- or sheet-like shape corresponding to the method of pattern transfer. The size of the projection/recess-type carbon structural body is not particularly limited either, but the projection/recess-type carbon structural body has a major axis with a length of generally 1 μm or greater, preferably 5 μm or greater, and generally 1 mm or smaller, preferably 100 μm or smaller as views in a plan view. The thickness of the projection/recess-type carbon structural bodies is not particularly limited, but the projection/recess-type carbon structural bodies have a thickness of generally 0.1 μm or greater, preferably 0.5 μm or greater, and generally 100 μm or smaller, preferably 20 μm or smaller.

### Colloid Crystal-Type Carbon Structural Body:

The colloid crystal-type carbon structural body has a structure in which at least thirty colloidal carbon particles are aggregated and bonded together. Although the shape of individual carbon particles is not particularly limited, the colloid crystal-type carbon structural body is usually an aggregate of particles generally having a particle size in the range of 5 nm to 100 μm and very narrow particle size distribution.

### II-3. Other Matters

The carbon structural bodies of the present invention may be crystalline or non-crystalline. The crystallinity of the carbon structural bodies can be controlled by appropriately selecting the precursor polymer to be used or by controlling the density of the inorganic coating layer as described before.

It is particularly preferred that the carbon structural bodies of the present invention have crystallinity. When the carbon structural bodies of the present invention have crystallinity, the crystal structures may be divided into three types according to the direction of the crystals.

The first type is the crystal structure in which the crystals are laminated in a direction perpendicular to the longitudinal direction of the structure. When the carbon structural bodies of the present invention have this crystal structure, at least some portions of the outer peripheries of the carbon structural bodies have a structure in which the ends of carbon crystals are exposed or a structure in which carbon net planes are in the form of loops.

FIG. 6 is a view illustrating an example of an outer periphery of a carbon structural body of the present invention having a structure in which the ends of carbon crystals are exposed and a structure in which carbon net planes are in the form of loops. More specifically, FIG. 6 is an enlarged cross-sectional view schematically illustrating a portion of an outer peripheral surface of a carbon structural body. In FIG. 6, the left side corresponds to the inside of the carbon structural body, while the right side corresponds to the outside of the carbon structural body. In addition, the directions of carbon crystals are schematically represented by the curved lines in FIG. 6.

The structure in which the ends of the carbon net planes on the side of the outer surface of the carbon structural body are not closed as designated as “a” in FIG. 6 corresponds to the structure in which the ends of carbon crystals are exposed at surfaces of carbon structural bodies (which will be hereinafter referred to simply as “crystal end exposed structure” as needed). The structure in which the ends of the carbon net planes on the side of the outer surface of the carbon structural body are connected to each other as designated as “b” in FIG. 6 corresponds to the loop structure of carbon net planes at surfaces of carbon structural bodies (which will be hereinafter referred to simply as “loop-type structure” as needed). The loop-type structure is usually formed in up to the twentieth carbon net plane. In addition, the surface shape of the carbon structural body (the crystal end exposed structure and the loop-type structure) can be observed on a TEM photograph taken at a magnification of 800,000 times.

In the carbon structural bodies of the present invention, the crystal end exposed structure and the loop-type structure usually exist at least some portions of the outer peripheries thereof. In general, it is said in the carbon fiber field that when the crystal end exposed structure is heated, the atomic elements at the crystal ends are removed to form a loop-type structure.

The second type is the crystal structure in which the carbon net planes are laminated in a direction generally horizontally with respect to the longitudinal direction of the structure.

The third type is the crystal structure in which the carbon net planes are laminated along hollow spaces surrounded by carbon walls. Here, the carbon net planes are not necessarily continuous for a long distance (for example, for 100 nm or more), and short carbon net planes may be aligned generally along the outer peripheries of the voids.

When the carbon walls are crystalline, the laminate direction of the crystals can be determined from the contrast in a TEM image taken at a magnification of 100,000 to 800,000 times.

The carbon structural bodies of the present invention are also characterized by having voids defined by carbon crystal walls. The term “having voids” as used herein is intended to include “having isolated voids” in the particles and “having hollow spaces” which are not completely isolated but communicated with the outside via an opening. The term “defined by carbon walls” as used herein is intended to include the case where the carbon structural bodies have isolated inner hollow spaces (voids) which are not communicated with the outside in a broad sense and the case where some portions of the carbon wall are missing so that the hollow spaces in the carbon structural body are communicated with the outside. Therefore, in this specification, “void” is a subordinate concept of “hollow space.”

The number of the “voids” in the carbon structural bodies of the present invention is at least one. The voids generally occupy 5% or more, preferably 10% or more, more preferably 30% or more, of the volume of the carbon forming the carbon structural bodies. The volume of the voids can be determined using a scanning electron microscope or transmission electron microscope. When the carbon walls are thick, a sample piece may be observed under a microscope. The “hollow spaces” in the carbon structural bodies of the present invention may not necessarily be filled with air as long as they are not filled with carbon. The hollow spaces may be filled with liquid or another solid.

The carbon structural bodies of the present invention have a pattern structure. Thus, the honeycomb structure carbon structural bodies can be used for cell culture substratums, filters, photonic crystals and so on, for example. The carbon structural bodies having a pillar structure can be applied to field emission displays. The dimple-type carbon structural bodies can be used to scatter light or prevent scattering of light and for cell culture substratums. The carbon structural bodies having a projection-recess structure can be used as a material for controlling hydrophilicity or hydrophobicity and as a material for controlling microrheologic properties.

The surface characteristics of the carbon structural bodies of the present invention may be determined by the surface characteristics of the proto-shaped mold used for the production thereof or can be controlled by an aftertreatment after the production. In particular, when SiO₂ is used for the proto-shaped mold, it can be expected that the wettability of the resulting carbon structural bodies to a hydrophilic solvent improves. The reason for that is believed to be because hydroxyl groups or carbonyl groups exist on the surfaces of the carbon structural bodies.

### III. Aggregate of Carbon Structural Bodies

An aggregate of carbon structural bodies of the present invention (which will be hereinafter referred to simply as “aggregate of the present invention” as needed) is an aggregate of the carbon structural bodies of the present invention as described above.

### IV. Dispersion of Carbon Structural Bodies

A dispersion of carbon structural bodies of the present invention (which will be hereinafter referred to as “dispersion of the present invention”) will be described below. The dispersion of the present invention is characterized in that the carbon structural bodies of the present invention or the aggregates of the present invention are dispersed in a dispersion medium.

The dispersion medium is not particularly limited and may be a polar solvent or nonpolar solvent. As the polar solvent, there may be mentioned, for example, water; alcohols such as methanol, ethanol and isopropyl alcohol; glycols such as ethylene glycol and propylene glycol; ethers such as tetrahydrofuran and diethyl ether; monoalkyl ethers of glycol such as ethylene glycol monoethyl ether, ethylene glycol monomethyl ether and propylene glycol monomethyl ether; ketones such as acetone and methyl ethyl ketone; esters such as ethyl acetate; and carbonates such as ethylene carbonate and propylene carbonate. Examples of the nonpolar solvent include alkanes, aromatic compounds and mixtures thereof. Of these, the polar solvents are preferred since they have high affinity and high dispersibility, and particularly preferred are water and alcohols.

Incidentally, a highly dispersed composite can be obtained by adding a substance which is highly dispersible in the dispersion medium, such as a water-soluble resin, an inorganic solvent-soluble resin, a cement, a silicate or a ceramic, to a dispersion medium in addition to the carbon structural bodies and by subsequently removing the dispersion medium.

The proportion of the carbon structural bodies in the dispersion medium is generally 0.1% by weight or higher and 10% by weight or lower. To disperse the carbon structural bodies in the dispersion medium, a mechanical shaking means such as paint shaker or ultrasonic irradiation means, as well as a mechanical stirring means, may be used. When necessary, a surfactant may be used.

As for carbon structural bodies improved in dispersibility by surface modification or by the use of a surfactant or high-molecule modifying agent, the particle size distribution index is measured on a sample without removing the modifying means from it.

### EXAMPLES

The present invention will be further described in detail below by way of examples. It should be noted that the present invention is not limited to the examples but may be embodied in other forms so far as they do not depart from the gist of the present invention.

### Example 1

### Honeycomb-Type Carbon Structural Bodies

Honeycomb-type precursor bodies were first synthesized in the following manner.

A mixture of polycarbonate having an average molecular weight of 28,000 and an amphiphilic polyacrylamide named Cap (formal name: dodecylacrylamide-ω-carboxyhexylacrylamide copolymer) mixed at a ratio by weight of 10:1 was used as the polymer (carbon-containing material). The mixture was dissolved in chloroform such that the total concentration of the polymers was 5 mg/L to prepare a polymer solution. The polymer solution was casted to a thickness corresponding to 5 mL on a glass petri dish with a diameter of 10 cm. A high-humidity air having a relative humidity of 70% was blown onto the polymer solution at a rate of 2 L/min to evaporate the chloroform used as the solvent, thereby obtaining precursor bodies having a honeycomb-type pattern structure. The honeycomb-type precursor bodies had non-through-holes having a diameter of about 3.7 μm, and had a thickness of about 5 μm.

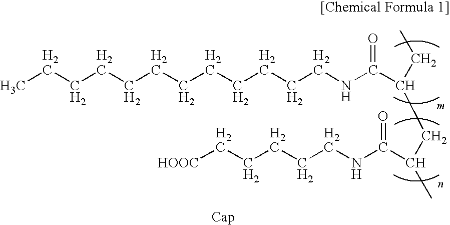

(wherein n and m are integers with the proviso that n:m=1:4)

A methyl silicate oligomer (MS51 manufactured by Mitsubishi Chemical Corporation) was added in an amount of 5.26 g to a mixed solution of 3.64 g of water and 4.65 g of ethanol and was dispersed therein. Then, 1 mol/L hydrochloric acid was added to the dispersion to adjust the pH of the dispersion to 2. The mixture was stirred at room temperature for 1 hour to hydrolyze the methyl silicate oligomer, thereby obtaining a silica sol as a uniform solution.

Next, 1.85 g of the silica sol were added to the above honeycomb-type precursor bodies, and the mixture was dried by heating on a hot plate at 40° C. for 5 hours, whereby the honeycomb-type precursor bodies were coated with dry silica gel.

Then, the honeycomb-type precursor bodies coated with dry silica gel were heated in an electric furnace from room temperature to 1,000° C. at a rate of 5° C./min under ambient pressure in a flowing nitrogen atmosphere, and maintained at 1,000° C. for 1 hour to carbonize the honeycomb-type precursor bodies. After that, heating was stopped and the sample was taken out 12 hours later when the electric furnace had cooled to room temperature. The sample was added to 60 mL of 1 mol/L sodium hydroxide aqueous solution. The mixture was charged in a pressure-resistance container and heated at 170° C. for 6 hours in an oven to dissolve the silica gel, thereby obtaining a dispersion liquid. The dispersion liquid was subjected to centrifugal separation at 18,000 rpm. The supernatant liquid was removed. The precipitates were washed with water. The washing was repeated in the same manner three times, thereby obtaining honeycomb-type carbon structural bodies.

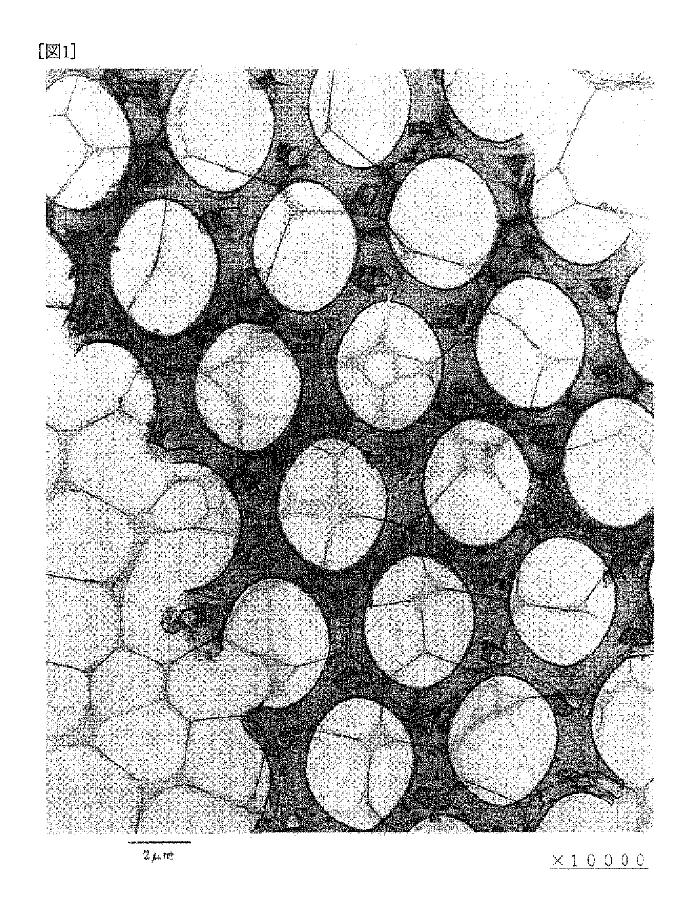

When the carbon structural bodies were observed under a TEM (transmission electron microscope; at magnification of 10,000 times), hollow honeycomb-type carbon structural bodies having through-holes with a major axis of about 4 μm and a minor axis of about 8.5 μm and having a planar shape of about 20 μm×30 μm were detected. A TEM photograph of the honeycomb-type carbon structural bodies is shown in FIG. 1.

For eight of the through-holes observed on the TEM photograph shown in FIG. 1, the distances from their centers of gravity to those of adjacent through-holes were measured. The value (%) obtained by dividing the difference between the maximum and minimum values of the distances by the average of the distances was 5.89. The value (%) obtained by dividing the difference between the maximum and minimum major axis lengths by the average of the major axis lengths was 1.31, and the value (%) obtained by dividing the difference between the maximum and minimum minor axis lengths by the average of the minor axis lengths was 2.91. The intersection of the major and minor axes of a through-hole was defined as the center of gravity of the through-hole.

### Comparative Example 1

Honeycomb-type precursor bodies prepared in the same manner as that in Example 1 were carbonized and washed with water in the same manner as that in Example 1 except that the precursor bodies were not coated with silica gel, thereby obtaining carbon structural bodies. When the carbon structural bodies were observed under SEM (scanning electron microscope) and TEM, no honeycomb-type pattern was detected.

### Example 2

### Fine Projection-Tune Carbon Structural Bodies

A polymer film (honeycomb-type precursor bodies) having a honeycomb-type pattern was prepared in the same manner as in Example 1. An adhesive tape was then attached to a surface of the polymer film, and then the adhesive tape was peeled in the thickness direction of the film, thereby obtaining precursor bodies having a fine projection-type pattern (fine projection-type precursor bodies). Observation in an oblique direction under an electron microscope showed that fine projections with very high regularity were formed on both the tape side and the glass petri dish side. Observation under a SEM showed that the projections had a thickness of about 300 nm and a length of about 2 μm, and were spaced at intervals of about 2.5 μm.

A silica sol was prepared in the same manner as in Example 1. The fine projection-type precursor bodies were removed and collected from the glass petri dish and mixed with 1.85 g of the silica sol. The mixture was heated on a hot plate at 40° C. for five hours, whereby the fine projection-type precursor bodies were coated with dry silica gel.

The fine projection-type precursor bodies coated with dry silica gel were carbonized in the same manner as that in Example 1. In addition, dissolution of the silica gel and washing with water were carried out in the same manner as that in Example 1, thereby obtaining fine projection-type carbon structural bodies.

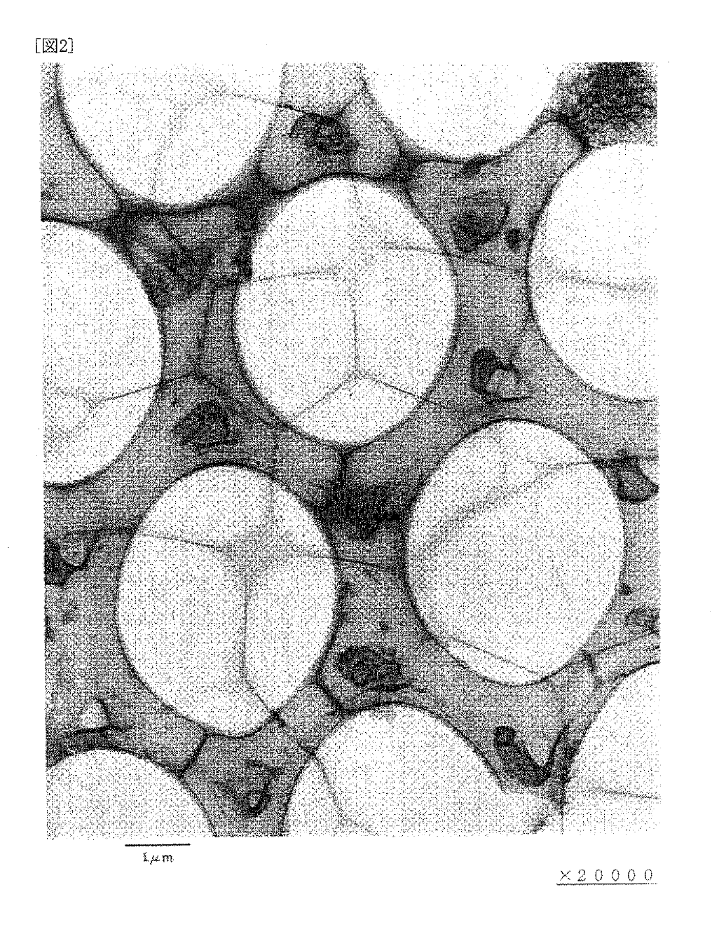

The fine projection-type carbon structural bodies were observed under a TEM (at a magnification of 10,000 times). Thus, the fine projections were found to have a thickness of about 250 nm and a length of about 2 μm, and to be spaced at intervals of about 2.5 μm. A TEM photograph of the fine projection-type carbon structural bodies is shown in FIG. 2.

For nine fine projections observed on the TEM photograph shown in FIG. 2, the distances from the centers of their bases to those of adjacent fine projections were measured on FIG. 2, and the value (%) obtained by dividing the difference between the maximum and minimum values of the distances by the average of the distances was 7.21.

### Comparative Example 2

Fine projection-type precursor bodies prepared in the same manner as that in Example 2 were carbonized and washed with water in the same manner as that in Example 2 except that the precursor bodies were not coated with silica gel, thereby obtaining carbon structural bodies. When the carbon structural bodies were observed under SEM and TEM, no projection-type pattern was found.

### Example 3

### Dimple-Type Carbon Structural Bodies

Polymer films having a honeycomb-type pattern were prepared in the following manner and used as molds. As the honeycomb-type polymer films, a polymer film made of Cap alone as used in Example 1 (which will be hereinafter referred to as “Cap-only film”), and a polymer film made of a mixture of Cap and PCL having a structure represented by the following formula (poly-ε-caprolactone: Mw (weight-average molecular weight): about 200,000, manufactured by Aldrich Chemical Co.) mixed at a ratio by weight of 1/10 (which will be hereinafter referred to as “Cap/PCL mixed film”) were prepared. Chloroform was used as an organic solvent in preparation of both the Cap-only film and Cap/PCL mixed-film.

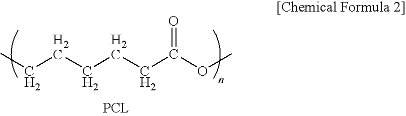

(wherein n is an integer).

Cap in an amount of 0.454 g and PCL in an amount of 4.54 g were weighed and dissolved in 1 L of chloroform to prepare a Cap/PCL solution. The Cap/PCL solution in an amount of 5 mL was dripped onto a solid substrate (mainly made of glass), and high-humidity (80%) air was blown onto the solution. The solution gradually became cloudy and an interference color was observed. When the solvent and water droplets were completely evaporated, a film remained. When the structure of the film was observed under optical microscope and SEM, a polymer film having a honeycomb-type pattern was found to be formed. The holes of the polymer film were communicated with each other in the film, generally vertically symmetric with respect to a plane extending through the center of the film, and linked with each other in a three-dimensional fashion. When the film was observed under a SEM, the holes were found to have a diameter of about 5 μm.

As a material to which the pattern of the honeycomb-type polymer film was to be transferred, a thermosetting resin called PDMS (“Sylgard 184” manufactured by Dow-Corning Corporation) was used. Liquid PDMS before solidification was poured onto the honeycomb-type polymer film on a slide glass, and cured by heating at 70° C. for 2 hours. The cured PDMS was separated from the slide glass, washed with benzene to remove residues from the honeycomb-type polymer film to be used as a mold, and dried, thereby obtaining a PDMS film having a microlens array-type pattern. When the PDMS film was observed under a SEM, the microlens-shaped fine pores were found to have a diameter of about 5 μm.

Another pattern transfer was performed using the PDMS film having a microlens array-type pattern as a mold in the following manner to prepare precursor bodies having a dimple-type pattern. As a material to which the pattern was to be transferred (material of dimple-type precursor bodies), an acrylonitrile/methyl acrylate/methacrylic acid terpolymer prepared by emulsion polymerization was used. The terpolymer was prepared in the following manner. First, fine particles of an acrylonitrile-methyl acrylate copolymer were synthesized as follows. Dodecyl sodium sulfate in an amount of 0.32 g was dissolved in 145 g of water. To the obtained solution, a mixture of 12.71 g of acrylonitrile, 1.83 g of methyl acrylate, 0.46 g of methacrylic acid and 0.3 g of n-butyl mercaptan was added. The resulting mixture was then heated from room temperature with stirring at 300 rpm in a flowing atmosphere of nitrogen gas. When a temperature of 60° C. was reached, an aqueous potassium persulfate solution (a solution of 0.1 g of potassium persulfate dissolved in 5 g of water) was added to the mixture to initiate polymerization. Then, the polymerization was continued at 70° C. for three hours. After the reaction had been terminated, water was removed from the reaction mixture, thereby obtaining a suspension containing 12.5 g of acrylic resin particles having an average particle size of 130 nm (measured with the dynamic light-scattering particle size distribution meter described before). The proportion of acrylonitrile units in the resin particles calculated from the amount of nitrogen determined by elementary analysis (C, H, N) was 79.5% by weight, and the weight-average molecular weight in terms of polystyrene (PSt) by size exclusion chromatography (SEC) was 4.1×10⁴. The suspension was filtered to remove residual monomer, initiator residues and so on, and the resulting fine particles were then dried at 80° C., thereby obtaining an acrylonitrile/methyl acrylate/methacrylic acid terpolymer (which will be hereinafter referred to simply as “ternary polymer”).

The obtained ternary polymer was dissolved in DMF (dimethylformamide) to a concentration of about 10 g/L. The ternary polymer solution was dripped in an amount of 10 mL onto a glass petri dish, and the microlens array-shaped PDMS film was placed on the solution. This was dried in a vacuum for four hours, and then the PDMS film was peeled off, thereby obtaining dimple-type precursor bodies of the ternary polymer. Observation under a SEM showed that the dimple-type precursor bodies had a pore diameter of about 5 μm.

A silica sol was prepared in the same manner as that in Example 1. The above dimple-type precursor bodies were removed from the glass petri dish, and mixed with 1.85 g of the silica sol. The mixture was dried by heating on a hot plate at 40° C. for 5 hours, whereby the dimple-type precursor bodies were coated with dry silica gel.

The dimple-type precursor bodies coated with dry silica gel were carbonized in the same manner as that in Example 1. In addition, dissolution of the silica gel and washing with water were carried out in the same manner as that in Example 1, thereby obtaining dimple-type carbon structural bodies.

When the dimple-type carbon structural bodies were observed under a SEM (at a magnification of 5,000 times), a dimple-type pattern in which semispherical fine pores with a diameter of about 5 μm were regularly formed was observed. A SEM photograph of the dimple type carbon structural bodies is shown in FIG. 3.

For eight of the openings of the dimple structure observed on the TEM photograph shown in FIG. 1, the distances from their centers of gravity to those of adjacent openings were measured. The value (%) obtained by dividing the difference between the maximum and minimum values of the distances by the average of the distances was 3.22. The value (%) obtained by dividing the difference between the maximum and minimum major axis length by the average of the major axis length was 4.12, and the value (%) obtained by dividing the difference between the maximum and minimum minor axis lengths by the average of the minor axis length was 3.52. The intersection of the maximum major axis or maximum diagonal and the minimum minor axis or minimum diagonal of a dimple was defined as the center of gravity of the dimple.

### Comparative Example 3

Dimple-type precursor bodies prepared in the same manner as that in Example 3 were carbonized and washed with water in the same manner as that in Example 3 except that the precursor bodies were not coated with silica gel, thereby obtaining carbon structural bodies. When the carbon structural body was observed under SEM and TEM, no dimple-type pattern was found.

### Example 4

### Projection/Recess-Type Carbon Structural Bodies

A polycarbonate plate with a size of about 1 cm square having a surface in which grooves with a width of about 0.2 and a length of about 0.25 to 1 μm were formed by a thermal nanoimprint method was used as a precursor body (projection/recess-type precursor body) for the production of projection/recess-type carbon structural bodies.

The projection/recess-type precursor bodies were subjected to coating with dry silica gel, carbonization, dissolution of silica gel and washing with water in the same manner as that in Example 1, thereby obtaining projection/recess-type carbon structural bodies.

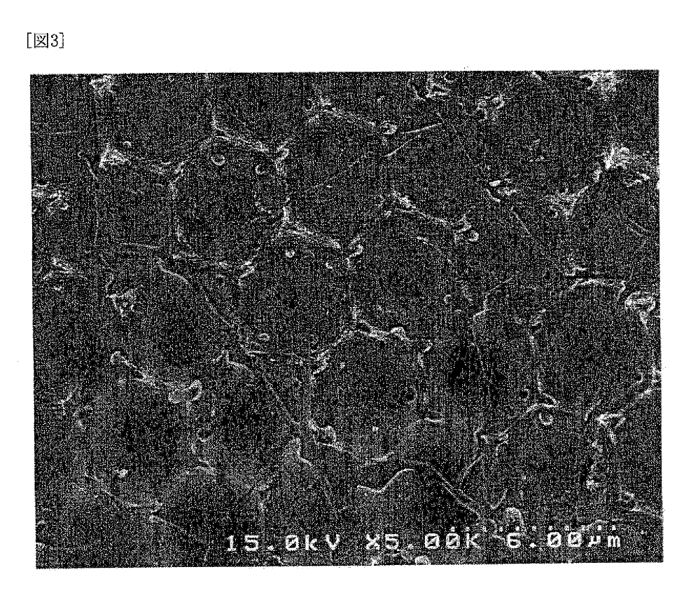

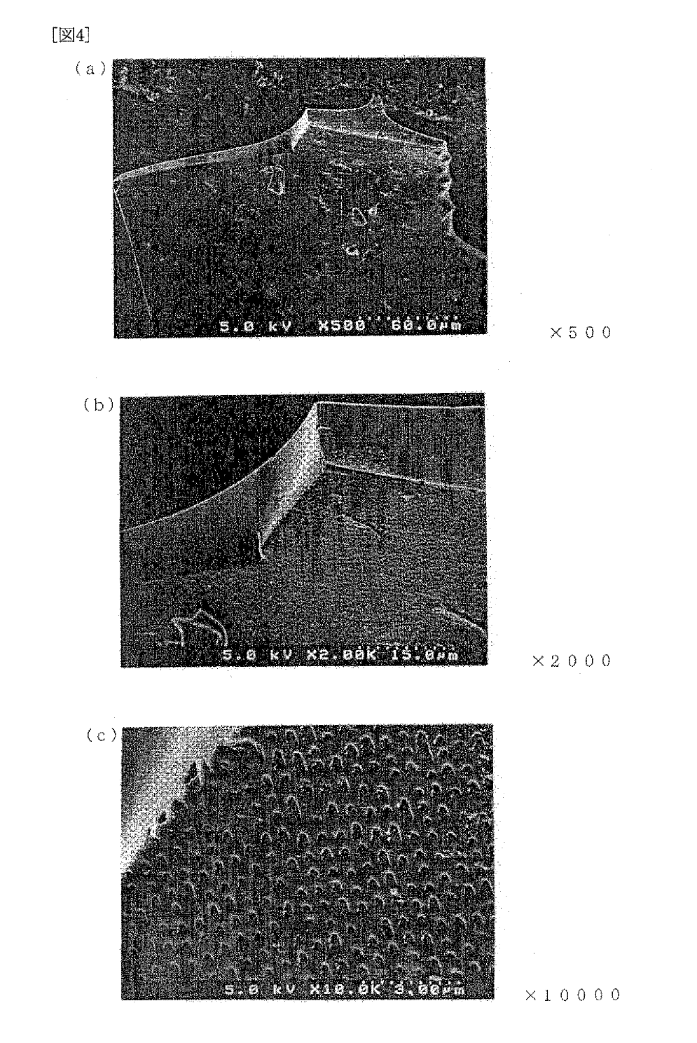

When the projection/recess-type carbon structural bodies were observed under a SEM (at a magnification of 10,000 times), a projection/recess-type pattern having grooves with a width of about 0.2 μm and a length of about 0.25 to 1 μm were found to be formed. SEM photographs of the projection/recess-type carbon structural bodies are shown in FIG. 4(a) to FIG. 4(c).

### Comparative Example 4

Projection/recess-type precursor bodies prepared in the same manner as that in Example 4 were carbonized and washed with water in the same manner as that in Example 4 except that the precursor bodies were not coated with silica gel, thereby obtaining carbon structural bodies. When the carbon structural bodies were observed under a SEM, no projection/recess-type pattern was found.

### Example 5

### Colloid Crystal-Type Carbon Structural Bodies

First, fine particles of an acrylonitrile/methyl acrylate copolymer (which may be hereinafter of “acrylic resin fine particles”) were synthesized in the following manner. A mixture of 12.71 g of acrylonitrile, 1.83 g of methyl acrylate and 0.46 g of methacrylic acid was added to 145 g of water, and the resulting mixture was heated from room temperature with stirring at 300 rpm in a flowing atmosphere of nitrogen gas. When a temperature of 60° C. was reached, an aqueous potassium persulfate solution (a solution of 0.1 g of potassium persulfate dissolved in 5 g of water) was added to the mixture to initiate polymerization. Then, the polymerization was continued at 70° C. for 3 hours. After the reaction had been terminated, water was removed from the reaction mixture, thereby obtaining a suspension containing 12.5 g of acrylic resin fine particles having an average particle size of 330 nm (measured under a SEM).

The acrylic resin fine particles were taken out of the suspension in an amount of 0.5 g in dry weight, and dried at 90° C. to cause the acrylic resin fine particles to aggregate, thereby obtaining precursor bodies having a colloid crystal-type pattern.

The colloid crystal-type precursor bodies were successively subjected to coating with dry silica gel, carbonization, dissolution of silica gel and washing with water in the same manner as that in Example 1, thereby obtaining colloid crystal-type carbon structural bodies.

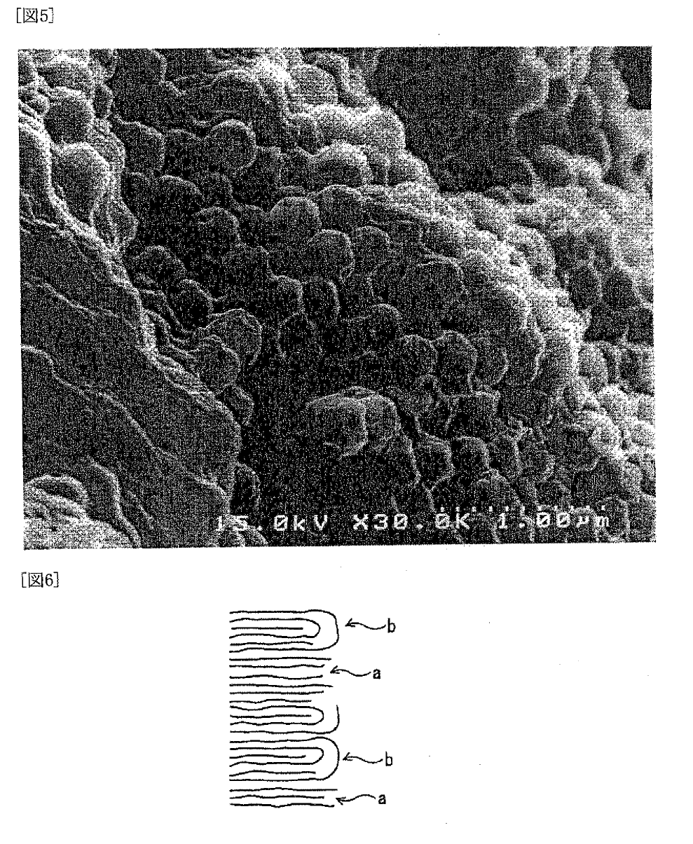

When the colloid crystal-type carbon structural bodies were observed under a SEM (at a magnification of 30000 times), a colloid crystal-type pattern formed by hollow carbon fine particles with a diameter of about 300 nm bonded together were detected. A SEM photograph of the colloid crystal-type carbon structural bodies is shown in FIG. 5.

### Comparative Example 5

Colloid crystal-type precursor bodies prepared in the same manner as that in Example 5 were carbonized and washed with water in the same manner as in Example 5 except that the precursor bodies were not coated with silica gel, thereby obtaining carbon structural bodies. When the carbon structural bodies were observed under a SEM, the shapes of the fine particles did not remain.

### INDUSTRIAL APPLICABILITY

The carbon structural bodies, and the aggregate and dispersion of the carbon structural bodies obtained in the present invention can be advantageously used in a wide variety of fields such as cell culture substratum, filter, photonic crystal, field emission display, light-diffusing agent, light scattering preventing agent, cell culture substratum, material for controlling hydrophilicity or hydrophobicity, and material for controlling microrheologic properties.

1. A process for producing a carbon structural body comprising forming a carbon-containing material into a pattern, then coating the obtained pattern with a proto-shaped mold, and calcining and carbonizing the coated pattern.

2. A process for producing a carbon structural body according to claim 1, wherein a method for said forming of the carbon-containing material into a pattern is at least one method selected from the group consisting of a nanoimprint method, a soft lithography method and a self-assembly method.

3. A carbon structural body produced by the process for producing a carbon structural body as defined in claim 1.

4. A carbon structural body according to claim 3 which has voids.

5. A carbon structural body according to claim 3, which has a surface having regularly arranged fine pores.

6. A carbon structural body according to claim 3 which has a surface having regularly arranged fine projections.

7. A carbon structural body comprising voids defined by carbon walls, and a surface having regularly arranged fine pores.

8. A carbon structural body according to claim 7, wherein the fine pores are through-holes.

9. A carbon structural body comprising voids defined by carbon walls, and a surface having regularly arranged fine projections.

10. A carbon structural body comprising a plurality of particles having voids defined by carbon walls and bonded to each other.

11. An aggregate of carbon structural bodies comprising aggregated carbon structural bodies as defined in claim 3.

12. A dispersion of carbon structural bodies comprising aggregates of carbon structural bodies as defined in claim 11 which are dispersed in a dispersion medium.
